(19) United States
(12) Patent Application Publication
(10) Pub. No.: US 2008/0087101 A1
(43) Pub. Date: Apr. 17, 2008

(54) PARTICULATE MATTER SENSOR

(75) Inventor: Athanasios G. Konstandopoulos, Thessaloniki (GR)

Correspondence Address: DITTHAVONG MORI & STEINER, P.C., 918 Prince St., Alexandria, VA, 22314, US

(73) Assignees: Athanasios G. Konstandopoulos, Thessaloniki (GR); IBIDEN CO., LTD, Ogaki-shi (JP)

(21) Appl. No.: 11/852,170

(22) Filed: Sep. 7, 2007

(30) Foreign Application Priority Data
Oct. 17, 2006 (EP) 06386033.2

(51) Int. Cl. G01F 1/34; G01K 13/02

(52) U.S. Cl. 73/861.42; 374/143; 73/700

(57) ABSTRACT

A particulate matter detection sensor includes a particulate matter detection filter and a differential pressure measuring part measuring a differential pressure between an inlet and an outlet of the particulate matter detection filter. The particulate detection filter has a filtration area of about 0.1 to about 100 cm².

### CROSS-REFERENCE TO RELATED APPLICATIONS

The present application claims priority under 35 U.S.C. §119 to European Patent Application No. 06386033.2 filed on Oct. 17, 2006. The contents of this European Patent application are incorporated herein by reference in their entirety.

### BACKGROUND OF THE INVENTION

1. Field of the Invention

The present invention relates to particulate matter sensor.

2. Discussion of the Background

Conventionally, a diesel particulate filter (DPF) of porous ceramic has been used for collecting particulate matter (PM) primarily of C (carbon) emitted from a diesel engine. With such a diesel particulate filter, there occurs gradual deposition of particulate matter with continual use thereof, and thus, it has been practiced in the art of exhaust gas purifying apparatus that uses a diesel particulate filter to remove the deposited particulate matter by causing a burning process inside the diesel particulate filter periodically and regenerate the diesel particulate filter.

It is preferable that such regeneration of the diesel particulate filter is conducted during the operation of the diesel engine, without replacing or dismounting the filter, and thus, it is practiced in the art to carry out fuel injection in the state that the piston is moving down in the cylinder following combustion to form a high temperature gas (post injection process). Thereby, the deposited particulate matter is burned with the high temperature gas thus formed.

FIG. 1 shows the overall construction of a conventional exhaust gas purifying system of a diesel engine equipped with a diesel particulate filter according to a related art of the present invention.

With the conventional exhaust gas purifying system explained with reference to FIG. 1, it should be noted that such regeneration of filter is conducted each time the vehicle has traveled a predetermined mileage such as 500 km, over the duration of 10 minutes, for example.

In the case the filter regeneration by way of post injection has been conducted impartially, the regeneration is carried out irrespective of actual amount of collection of the particulate matter in the filter. Thus, in order to ensure that there occurs no excessive deposition of the particulate matter in the filter, there is a need to set the interval of filter regeneration to be shorter than what is actually needed for the sake of safety.

On the other hand, there is a known construction of carrying out regeneration of the diesel particulate filter 12B by way of posit injection as shown in FIG. 3, in which a differential pressure ΔP is measured between the upstream side and downstream side of the diesel particulate filter 12B and the posit injection is carried out when the foregoing differential pressure ΔP has reached a predetermined value. Reference should be made to the U.S. Pat. No. 6,952,920.

Further, U.S. Pat. No. 5,651,248 describes the construction that uses, in addition to the diesel particulate filter, a detection filter and evaluates the amount of the particulate matter collected in the detection filter by measuring the electric resistance. According to this technology, the particulate matter collected by the diesel particulate filter and the particulate matter collected by the detection filter are subjected to burning by using a heater when the detected resistance has decreased below a predetermined value. With this, regeneration of filter is achieved.

The contents of U.S. Pat. Nos. 6,952,920 and 5,651,248 are incorporated herein by reference in their entirety.

### SUMMARY OF THE INVENTION

In an aspect of the present invention, a particulate matter detection sensor includes a particulate matter detection filter; and a differential pressure measuring part measuring a differential pressure between an inlet and an outlet of the particulate matter detection filter.

The particulate matter detection filter has a filtration area of about 0.1 to about 1000 cm².

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram showing an overall engine system that uses a conventional exhaust gas purifying apparatus;

FIG. 2A is a diagram showing a schematic construction of a diesel particulate filter;

FIG. 2B is a diagram showing a constituting element of the diesel particulate filter;

FIG. 2C is a diagram showing the operational principle of the diesel particulate filter;

FIG. 2D is a diagram showing the state of the particulate matter collected by the diesel particulate filter;

FIG. 3 is a diagram showing the overall construction of a conventional engine system that uses an exhaust gas purifying apparatus according to a related art of the present invention;

FIG. 4 is a diagram explaining the problem with the exhaust gas purifying apparatus of FIG. 3;

FIG. 5 is another diagram explaining the problem of the exhaust gas purifying apparatus of FIG. 3;

FIG. 6 is a diagram showing the construction of an exhaust gas purifying apparatus according to a first embodiment of the present invention;

FIG. 7A is a diagram showing the construction of a secondary diesel particulate filter used in FIG. 6;

FIG. 7B is a diagram explaining the principle of the secondary diesel particulate filter of FIG. 7A;

FIG. 8 is a diagram showing the construction of a particulate matter (PM) sensor that uses the secondary diesel particulate filter of FIG. 6;

FIG. 9 is a diagram explaining the effect of the embodiment of the invention;

FIG. 10 is a diagram showing examples of exhaust gas purifying experiment conducted by using the exhaust gas purifying apparatus of FIG. 6;

FIGS. 11A-11C are diagrams showing the construction of a secondary diesel particulate filter used with the experiment of FIG. 10;

FIGS. 12A-12D are diagrams explaining the mixing proportion of source materials of the secondary diesel particulate filter used with the experiment of FIG. 10;

FIG. 13 is a flow chart explaining the regeneration operation of the diesel particulate filter in the exhaust gas purifying apparatus according to a second embodiment of the present invention;

FIG. 14 is a flowchart explaining another regeneration operation of the diesel particulate filter of the exhaust gas purifying apparatus according to the second embodiment of the present invention;

FIG. 15 is a diagram showing the construction of a particulate matter sensor according to a third embodiment of the present invention;

FIG. 16 is a diagram showing the construction of a particulate matter sensor according to a fourth embodiment of the present invention;

FIG. 17 is a diagram showing the construction of a particulate matter sensor according to a modification of FIG. 16.

### DESCRIPTION OF THE EMBODIMENTS

The embodiments will now be described with reference to the accompanying drawings, wherein like reference numerals designate corresponding or identical elements throughout the various drawings.

According to an embodiment of the present invention, there is provided a particulate matter detection sensor, including: a particulate matter detection filter; and a differential pressure measuring part measuring a differential pressure between an inlet and an outlet of the particulate matter detection filter, wherein the particulate matter detection filter has a filtration area in the range of about 0.1 to about 1000 cm².

Preferably, the filtration area is in the range of about 1 to about 10 cm².

Preferably, the particulate matter detection filter has a wall gas permeability in the range of about 1.0×10⁻¹⁵ to about 1.0×10⁻¹¹ m².

Preferably, the wall gas permeability is in the range of about 1.0×10⁻¹³ to about 1.0×10⁻¹² m².

Preferably, the particulate matter detection sensor further includes a temperature measuring part measuring a temperature.

Preferably, the particulate matter detection sensor further includes a flow meter that measures a flow rate of an exhaust gas flowing through the particulate detection filter.

Preferably, the particulate matter detection sensor further includes a vessel, at least one of the particulate detection filter, the differential pressure measuring part, the temperature measuring part and the flow meter is accommodated in the vessel.

Preferably, the particulate detection filter includes any of SiC, aluminum nitride, silicon carbide, boron nitride, tungsten nitride, zirconium carbide, titanium carbide, tantalum carbide, tungsten carbide, alumina, zirconium oxide, cordierite, mullite, silica, and aluminum titanate.

Hereinafter, the embodiments of the present invention will be described in detail with reference to the drawings.

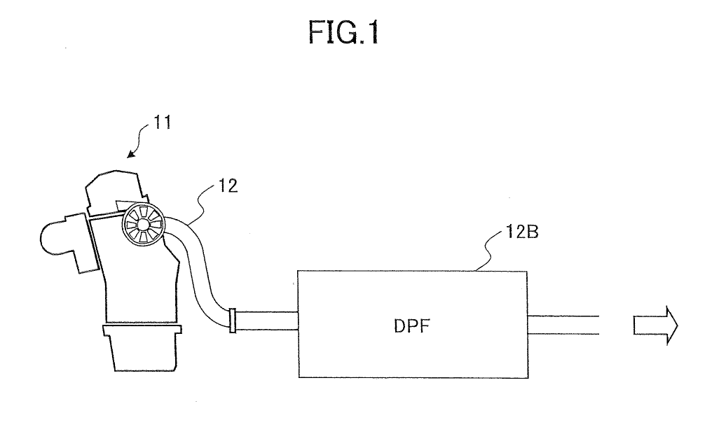

Referring to FIG. 1, a diesel engine 11 has an exhaust line 12, wherein there is provided a diesel particulate filter 12B in the exhaust line 12 for collecting the particulate matter contained in the exhaust gas and emitted from the diesel engine 11.

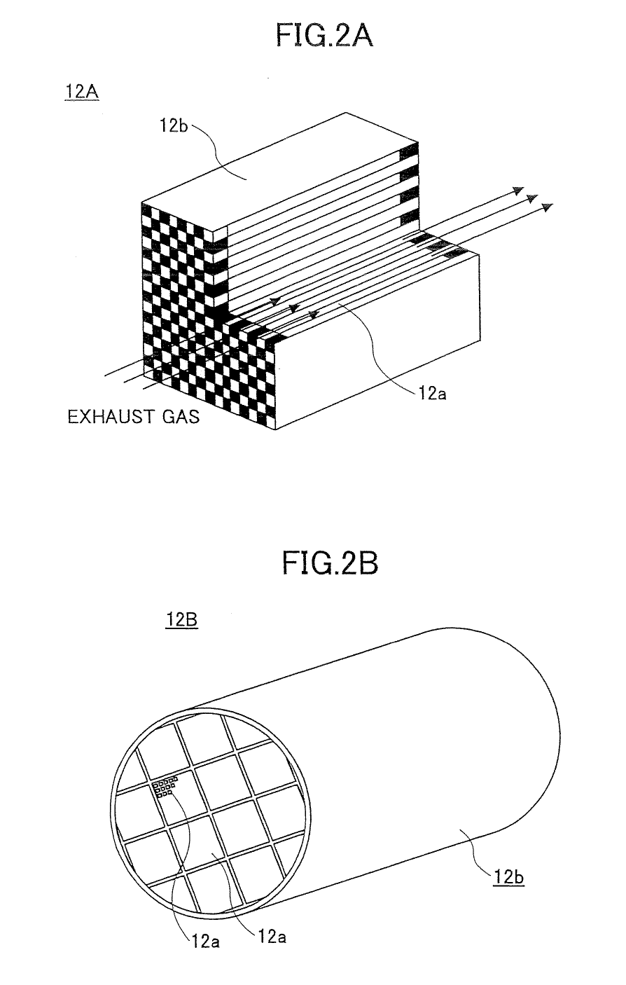

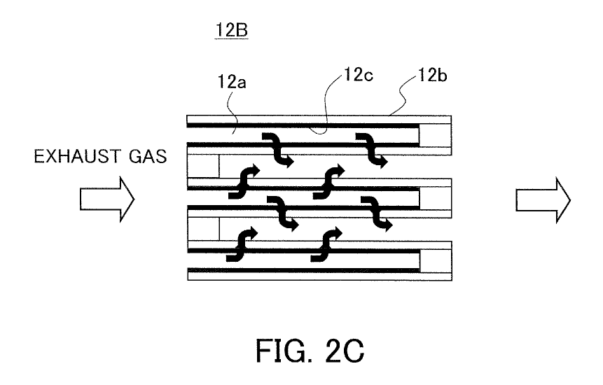

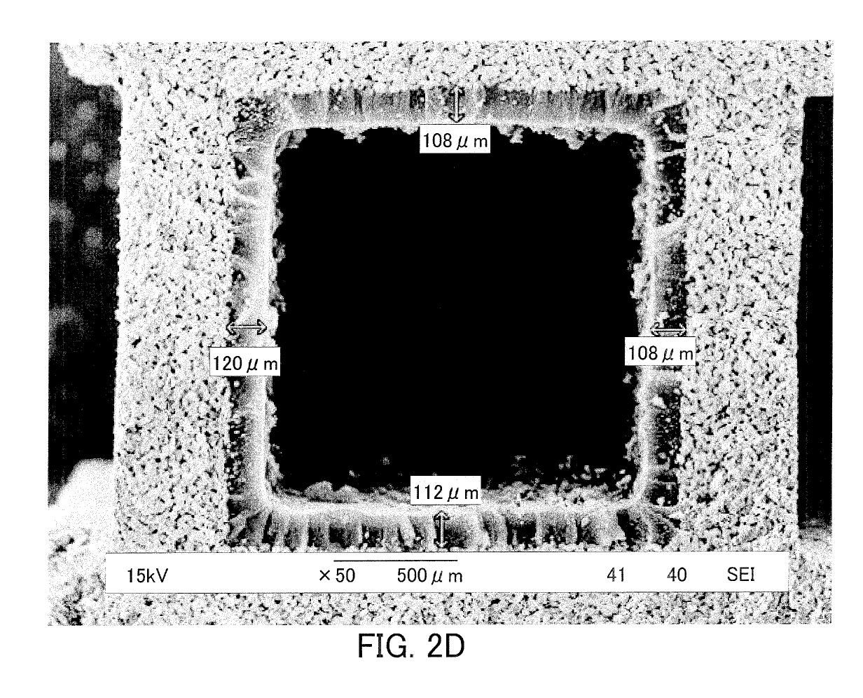

FIG. 2A shows the outline of the diesel particulate filter 12B while FIG. 2B shows an element that constitutes the diesel particulate filter.

The diesel particulate filter 12B is formed of a filter unit 12A of a porous ceramic, typically of SiC, wherein there are formed a large number of gas passages 12a in the filter unit 12A so as to extend from one end to the other end thereof with a cross-section of 1 mm×1 mm, for example.

Thereby, the diesel particulate filter 12B is formed by binding plural filter units (filter elements) 12A by a seal material (adhesion layer) and machining the peripheral part thereof such that the filter 12B as a whole has a cylindrical form. Further, the peripheral surface of the filter 12B is covered by a seal material (coating layer). There may be a case in which only one unit 12A is used in the diesel particulate filter 12B.

FIG. 2C shows the principle of the diesel particulate filter 12B.

As shown schematically in FIG. 2C, the plural gas passages 12a have their upstream ends or downstream ends closed alternately with regard to the direction of the exhaust gas flow from the engine, and the exhaust gas introduced to one such gas passage 12a passes to an adjacent gas passage by way of penetration through the porous member 12b of the filter 12B. Thereby, the particulate matter contained in the exhaust gas is collected by the porous member 12b as the exhaust gas penetrates therethrough, and there is caused deposition of the particulate matter 12c on the porous member 12b in the form of layer as shown in FIG. 2D.

Because the diesel particulate filter 12B thus causes deposition of the particulate matter contained in the exhaust gas therein, there is a need of regenerating the filter with suitable timing by conducting a regeneration process (burning of the deposited particulate matter), as described previously.

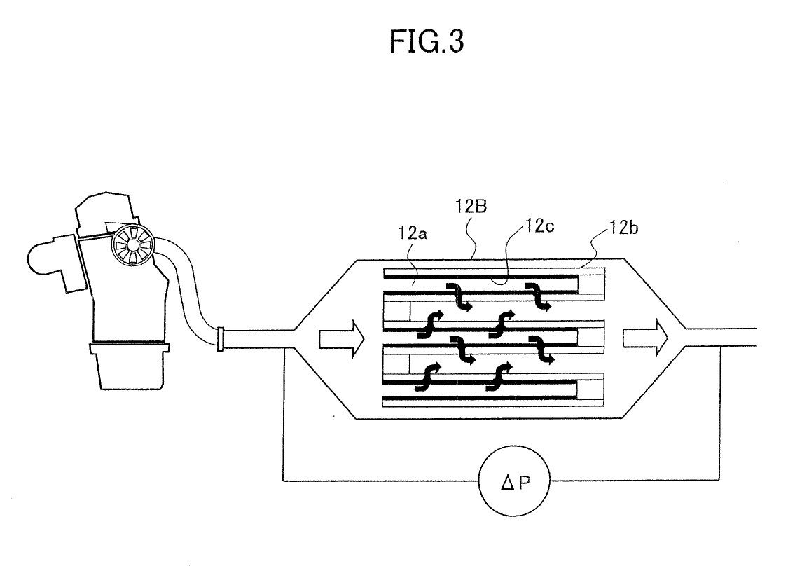

According to the conventional construction of FIG. 3, the regeneration of the diesel particulate filter 12B is carried out only when the differential pressure between the upstream side and the downstream side has reached the predetermined value, and unnecessary post injection process is suppressed. Thereby, the fuel efficiency of the vehicle driven with the diesel engine is improved.

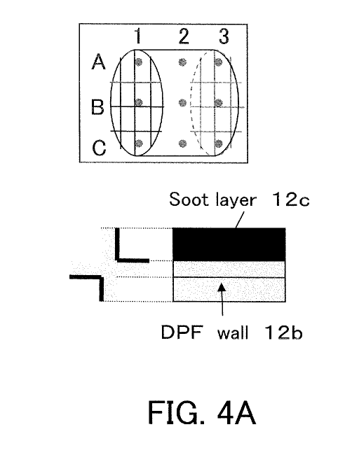

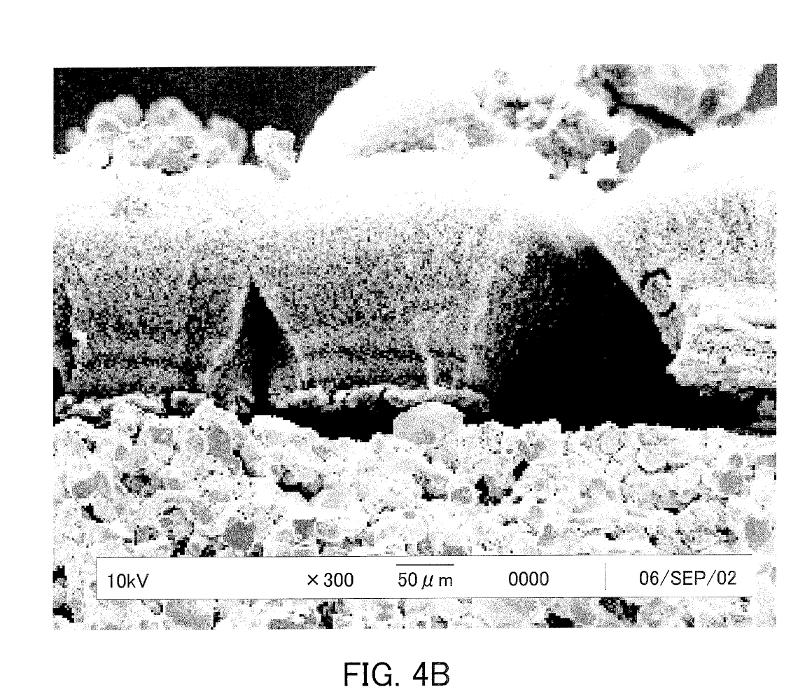

Unfortunately, collection of the particulate matter in the diesel particulate filter 12B is not uniform. As shown in FIG. 4, there is a difference of density or thickness in the collected particulate matter depending on the locations (A,1), (B,1), (C,1), (A,2), (B,2), (C,2), (A,3), (B,3), (C,3) in the filter 12B. Further, it can be seen that there is formed a cavity in the layer of the deposited particulate matter, wherein such a cavity formed in the layer of particulate matter provides as a local passage of exhaust gas. Existence of such a cavity indicates occurrence of uncontrolled burning in the collected particulate matter and indicates further that there has been caused local burning in the collected particulate matter.

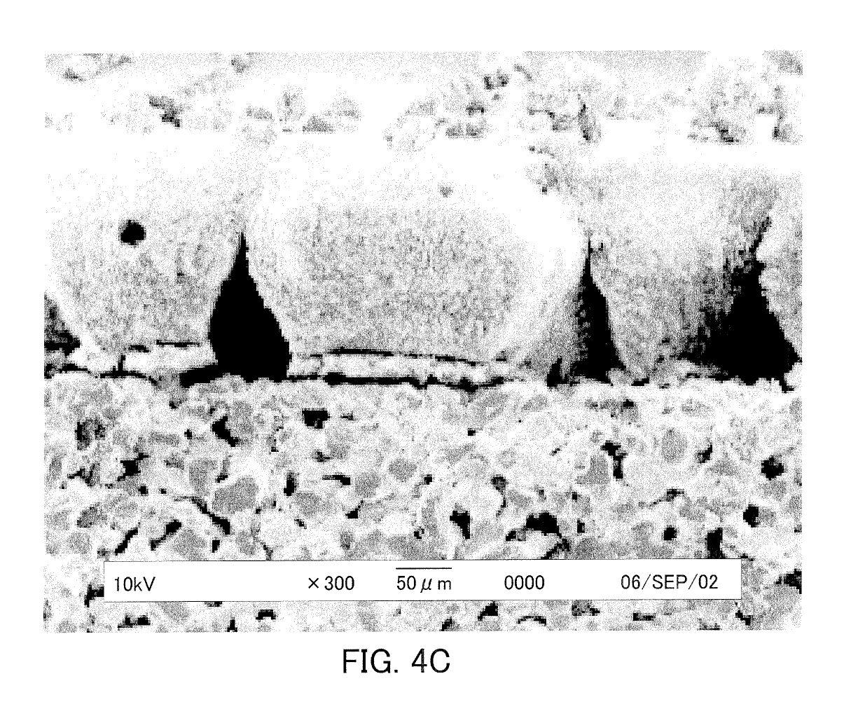

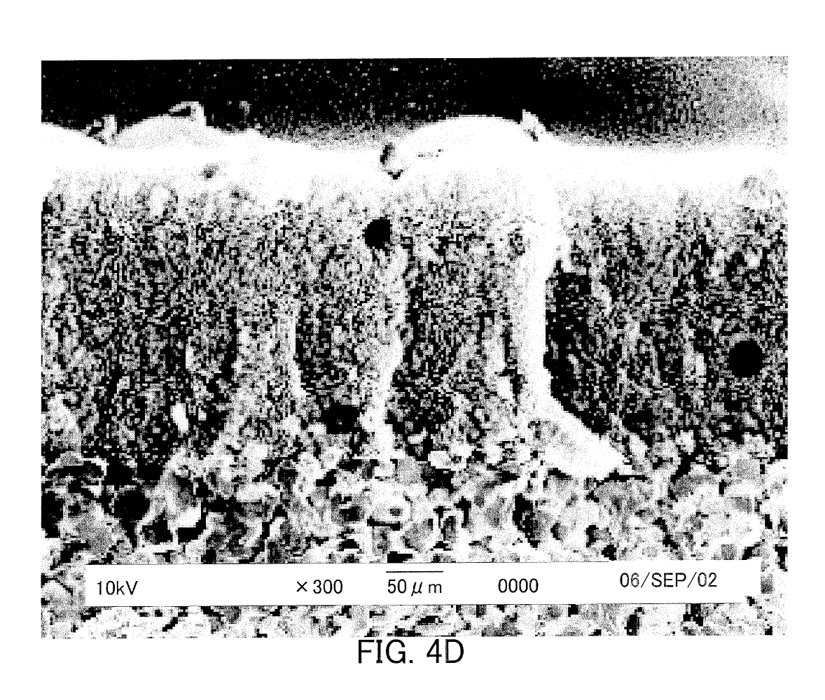

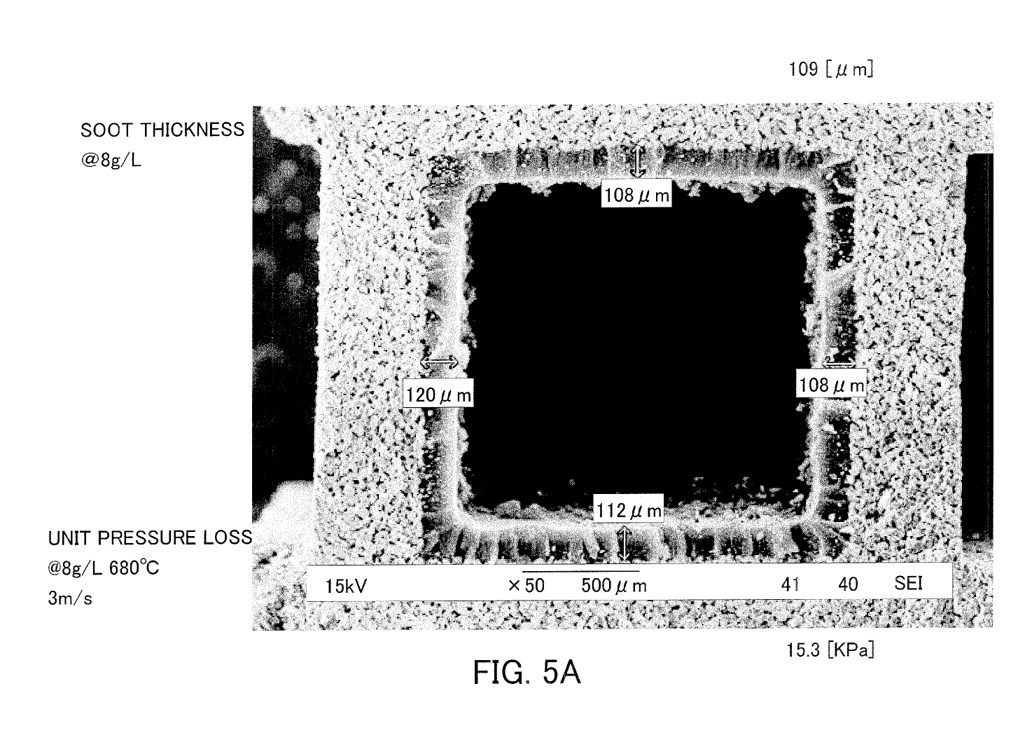

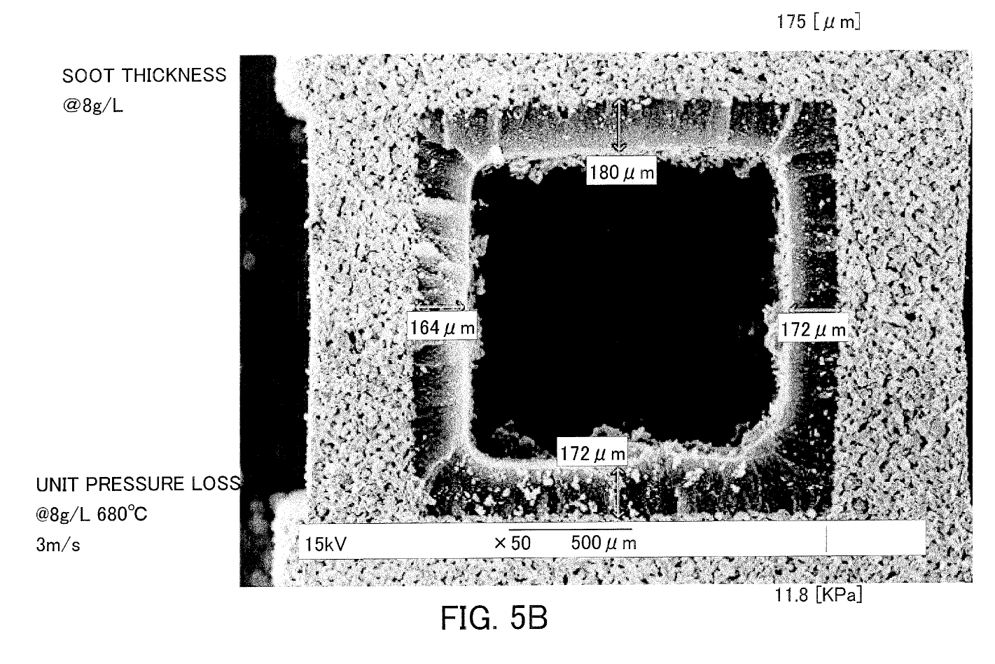

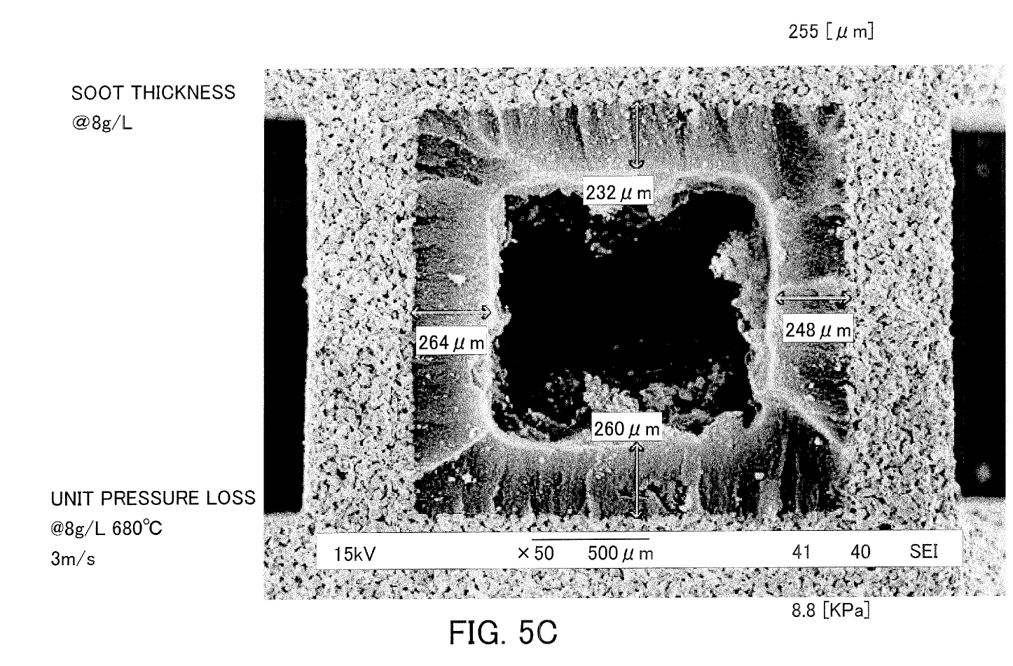

Further, as shown in FIG. 5, the density of the collected particulate matter can take different values even when the deposition amount of the particulate matter is identical. FIG. 5 shows that there is caused a large variation in the differential pressure according to the change of the thickness, even when the deposition amount is identical. In the examples of FIG. 5, for example, it should be noted that the deposition amount of the particulate matter is 8 g/L throughout. In spite of this, it can be seen in FIG. 5 that the differential pressure has changed from 15.3 kPa to 8.8 kPa when the thickness of the collected particulate matter has changed from 109 μm to 255 μm. Thus, it can be seen that there is caused approximately twice as large difference in the differential pressure.

Thus, when such non-uniform deposition or local cavity formation is caused in the particulate matter 12c collected in the conventional construction of FIG. 3, there can be caused an error of as much as approximately ±50% with regard to the evaluation of the actually deposited particulate matter and the differential pressure ΔP, with regard to theoretical calculation values. As a result of such an error, there is caused a large deviation in the relationship between the amount of the actually deposited particulate and the timing of regeneration. Further, in view of the fact that the exhaust gas pressure and the exhaust gas flow rate change with engine load or engine revolution, it is extremely difficult with the conventional construction of FIG. 3 to detect the deposition amount of the particulate matter in the diesel particulate filter 12B precisely.

On the other hand, this U.S. Pat. No. 5,651,248 has a drawback in that, in addition to the problem that the construction thereof becomes complex because of the need of providing a heater in the diesel particulate filter, there occurs electric power consumption at the time of regeneration of the diesel particulate filter. In order to save the electric power consumption at the time of filter regeneration, the technology of U.S. Pat. No. 5,651,248 selects the timing of executing the filter regeneration such that the regeneration operation is conducted at the time the temperature of the diesel particulate filter is higher than a predetermined temperature, except for the case in which the diesel particulate filter is in the critical state with regard to the deposition of the particulate matter and it is inevitable to carry out regeneration immediately. As a result, there is imposed a restriction on the timing of regenerating operation of the detection filter used for particulate detection with this technology, and the degree of freedom of regenerating operation of the particulate detection filter is restricted.

Further, with the technology of the U.S. Pat. No. 5,651,248, it is not possible to use the diesel particulate filter during the regeneration operation carried out by the heater, and because of this, there is provided a reserve diesel particulate filter and switches to this reserve diesel particulate filter during the regeneration process. However, such a construction requires two equivalent diesel particulate filters together with a switching valve, and there arises a problem in that the construction of the exhaust gas purifying apparatus becomes bulky. It is difficult to mount such an exhaust gas purifying apparatus on compact vehicles.

Further, with the technology of the U.S. Pat. No. 5,651,248, regeneration of the detection filter is carried out concurrently with the diesel particulate filter or consecutively to the diesel particulate filter, while such a construction cannot choose the timing of regeneration of the detection filter arbitrarily, and there is a problem that error tends to be caused in the regeneration timing of the diesel particulate filter, depending upon the state of the detection filter.

When regeneration of the diesel particulate filter and regeneration of the detection filter are carried out independently, there is caused a decrease of ventilation resistance in the detection filter upon regeneration thereof, and the exhaust gas starts to flow primarily through the detection filter. Thereby, there is caused an error in the detection of regeneration timing of the diesel particulate filter. From these reasons, the technology of U.S. Pat. No. 5,651,248 carries out the regeneration of the detection filter and the regeneration of the diesel particulate filter in synchronization as explained before.

Further, the technology of the U.S. Pat. No. 5,651,248 has a drawback in the points of: (a) ash deposition; and (b) large evaluation error caused by deterioration.

Further, with the technology of the U.S. Pat. No. 5,651,248, there arises another problem from the very principle thereof of measuring electric resistance of electrode for evaluating the deposition amount of the collected particulate matter.

As shown in FIG. 5, there can be a situation in which the thickness of the collected particulate matter changes in spite of the fact that the deposition amount thereof is the same. Now, when the thickness of the collected particulate matter is different, it becomes difficult to measure the electrical resistance precisely, and there tends to be caused error in the evaluation of the deposition amount.

Further, in the case there is caused a deposition of ash in the diesel particulate filter or detection filter after burning of the particulate matter, no precise measurement of electrical resistance is possible anymore and there tends to be caused a large error in the evaluation of the deposition amount.

Further, with the use of the detection filter, there is caused degradation in the filter or electrode with time or with use in the ambient of exhaust gas. Particularly, the electrode (terminal formed of a conductive metal) is formed by infiltrating a metal such as Cu, Cr, Ni, or the like, and thus, there is a tendency of causing problems of physical degradation, oxidation degradation and thermal degradation, such as oxidation, adhesion of impurities, cracking, corrosion, and the like.

When there is caused degradation in the filter or electrode, it is no longer possible to carry out precise measurement of the electric resistance and error is tend to be caused in the evaluation of the deposition amount of the particulate matter.

According to the embodiment of the present invention, it becomes possible to measure the deposition amount of particulate matter in the primary diesel particulate filter simply and easily, by using a particulate matter detection filter of a small volumetric capacity and having a filtration area of about 0.1 to about 1000 cm² and by measuring the differential pressure caused in such a particulate matter detection filter.

### First Embodiment

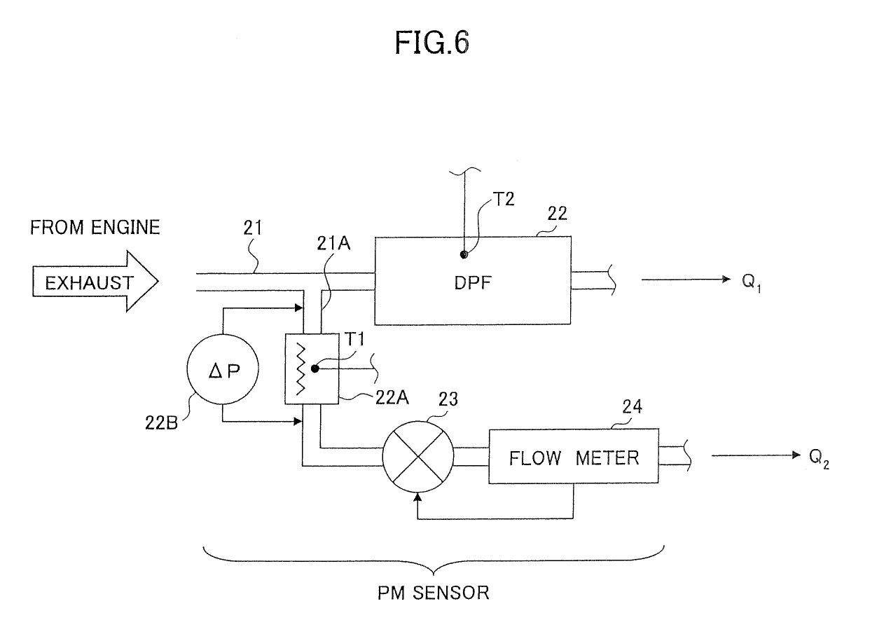

FIG. 6 shows the construction of an exhaust gas purifying apparatus 20 according to a first embodiment of the present invention.

Referring to the embodiment of FIG. 6, an exhaust gas from a diesel engine not illustrated is caused to flow into a primary diesel particulate filter (DPF) 22 similar to the one explained previously with reference to FIG. 2A via an exhaust line 21, and the primary diesel particulate filter (DPF) 22 collects the particulate matter in the exhaust gas as explained with reference to FIGS. 2C and 2D.

Further, with the construction of the embodiment of FIG. 6, a secondary exhaust line 21A is branched from the exhaust line 21 at an upstream side of the primary diesel particulate filter (DPF) 22, and a secondary diesel particulate filter 22A (called also particulate matter collection part of a particulate matter (PM) sensor) is provided to the secondary exhaust line 21A with a volume smaller than the volume of the primary diesel particulate filter (DPF) 22. Further, there is provided a differential pressure gauge 22B for measuring a differential pressure ΔP caused between an inlet and an outlet of the secondary diesel particulate filter 22A. Further, with the construction of the embodiment of FIG. 6, there are provided a flow meter 24 and a control valve 23 in the secondary exhaust line 21A at a downstream side of the secondary diesel particulate filter 22A, wherein the control valve 23 is used for maintaining the flow rate of the exhaust gas in the secondary exhaust line 21A constant based on the measurement made by the flow meter 24. It should be noted that the control valve 23 and the flow mater 24 may be provided anywhere on the secondary exhaust line 21A. Here, it should be noted that the secondary diesel particulate filter 22A, the differential pressure gauge 22B and the flow meter 24 constitutes together a particulate matter (PM) sensor that measures the amount of particulate contained in the exhaust gas. The foregoing particulate matter (PM) sensor may or may not include the flow meter 24. The particulate matter (PM) sensor may be defined to include a temperature measuring part (T1). Further, it is possible to provide a temperature measurement part T2 in the primary diesel particulate filter (DPF) 22.

It should be noted that the temperature measuring part in the exhaust line may be provided in any of: (1) interior of the primary diesel particulate filter, (2) interior of the secondary diesel particulate filter, (3) in a pipe connected thereto, (4) exterior of the primary diesel particulate filter, or (5) exterior of the secondary diesel particulate filter. From the viewpoint of precise measurement of the exhaust gas temperature, the arrangement of (1) or (2) is preferable, wherein the arrangement of (2) is thought more preferable.

In the embodiment of FIG. 6, the primary diesel particulate filter (DPF) 22 is formed of a porous ceramic of SiC, or the like having a porosity of about 35 to about 65% in the form of a honeycomb structure, wherein it can be seen that there are formed gas passages of a rectangular cross-section having a length of 1.1 mm, for example, for each edge in the cross-section taken perpendicular to the gas flow direction, in correspondence to the gas passages 12a of FIG. 2B, wherein the gas passages are arranged with a mutual separation of about 0.3 mm and form together a lattice pattern.

Here, it should be noted that, in the present invention, the particulate matter (PM) detection filter is called also a secondary diesel particulate filter.

As shown in FIG. 6, the particulate matter detection sensor of the present embodiment is formed by the secondary exhaust line 21A, the secondary diesel particulate filter 22A and the differential pressure gauge 22B measuring the differential pressure ΔP between the inlet and outlet of the secondary diesel particulate filter 22A. Therein, it will be noted that “particulate matter sensor” is defined as the part performing the function of particulate detection (constituting elements realizing the function of particulate matter detection).

Thus, with the particulate matter sensor of the embodiment of the present invention, the constituent elements of the particulate matter detection function may be provided in the form connected by pipes or in the form of an integral unit accommodating in a holder 22e, for example, or in a metal housing.

Further, as shown in the embodiment of FIG. 6, it is possible that the particulate matter sensor includes the control valve 23 or flow meter 24 in the form connected by pipes. Alternatively, the control valve 23 and the flow meter 24 may be integrated to the particulate matter sensor. Further, the particulate matter detection sensor may include the temperature measuring part T1.

In the case the temperature measuring part T2 is used for measurement of temperature of the exhaust gas in place of the temperature measuring part T1, the particulate matter sensor includes also the temperature measuring part T2.

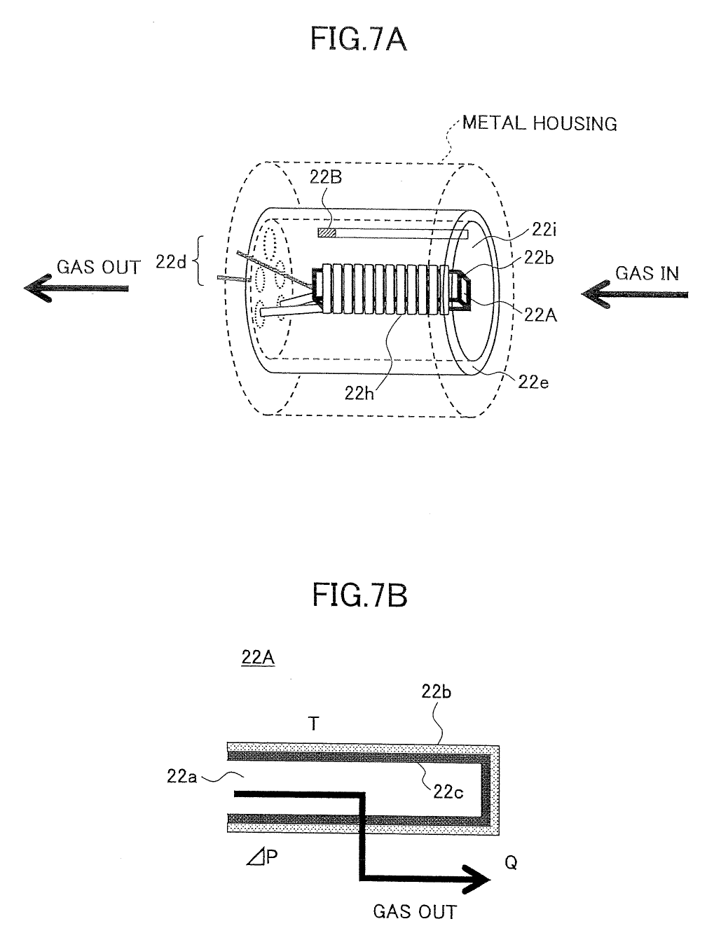

FIG. 7A shows the overall construction including the secondary diesel particulate filter 22A, while FIG. 7B shows the principle of the secondary diesel particulate filter 22A.

It should be noted that the secondary diesel particulate filter 22A may be formed of a porous ceramic similar to the primary diesel particulate filter (DPF) 22. In the case the secondary diesel particulate filter is formed of a porous ceramic, it is preferable that the secondary diesel particulate filter includes a cell 22b of a rectangular form. Therein, there is formed a single gas passage 22a having a volume of about 65 ml or less such as about 0.05 to about 65 ml, or about 5% or less such as about 0.05 to about 5% of the total volume of the exhaust gas passages (corresponding to passage 12a of FIG. 3) in the primary diesel particulate filter (DPF) 22. Alternatively, the gas passage 22a may have a filtration area of about 0.1 to about 1000 cm² (preferably about 1 to about 10 cm²). The gas passage 22a may have a rectangular cross-sectional shape, for example, and is formed in the state that one end thereof is closed (rear end is closed in the case of a cell). Here, it should be noted that the outer shape of the gas passage 22a or the outer shape of the secondary diesel particulate filter 22A (cell 22b) is not necessarily be identical to the cross-sectional shape of the gas passages of the primary diesel particulate filter (DPF) 22, and thus, they can be shaped to any arbitrary shape of circular, square, octahedral, elliptical, or the like. Further, it should be noted that the porous ceramic constituting the secondary diesel particulate filter 22A (cell 22b) is not necessarily be identical with the porous ceramic that forms the primary diesel particular filter (DPF) 22. Further, it should be noted that the secondary diesel particulate filter 22A (cell 22b) may be formed of a material other than ceramics.

By forming the gas passage 22a with the volume of about 5% or less of the exhaust gas passage (corresponds to the passage 12a of FIG. 3) in the primary diesel particulate filter (DPF) 22, or with the volume of about 65 ml or less, or with the filtration area of about 0.1 to about 1000 cm² (preferably about 1 to about 10 cm²), it becomes possible to measure the deposition amount of the particulate matter in the primary diesel particulate filter (DPF) 22 with a simple procedure.

The secondary diesel particulate filter 22A (cell 22b) is provided with a temperature measuring part for measuring the exhaust gas temperature T, and a thermocouple 22d is provided for the temperature measuring part. Further, a heater 22h is wound around the secondary diesel particulate filter (cell 22b) for incinerating a soot layer 22c deposited on the inner wall surface and regenerating the secondary diesel particulate filter 22A. Further, the cell 22b, the thermocouple 22d and the heater 22h are accommodated in a cylindrical holder 22e of SiO₂—Al₂O₃, or the like, by interposing an insulator 22i of Al₂O₃, or the like, and there is provided a diaphragm pressure gauge 22B in the holder 22e for measuring the differential pressure ΔP, in such a manner that the exhaust gas in the secondary exhaust line 21A is supplied to the pressure gauge 22B. The holder 22e is accommodated in a metal housing and is provided to the secondary exhaust line as the particulate matter (PM) sensor. The holder 22e may also be provided inside the pipe of the secondary exhaust line or may be provided inside the secondary exhaust line in the state accommodated in the metal housing.

Thus, when the exhaust gas in the secondary exhaust line 21A is introduced to the exhaust passage 22a of the secondary diesel particulate filter (cell 22b), the exhaust is caused to flow outside the cell through the wall surface of the secondary diesel particulate filter (cell 22b), and the particulate matter in the exhaust gas is collected similarly to the case of FIG. 2C. Thereby, the particulate matter deposits on the inner surface of the cell 22b to form a layer 22c.

With the present embodiment, the deposition amount of the particulate 22c thus collected and deposited on the inner wall surface of the diesel particulate filter 22 is calculated from the pressure difference ΔP and the exhaust gas temperature T and exhaust gas flow rate Q thus obtained by using the equation (1) below.

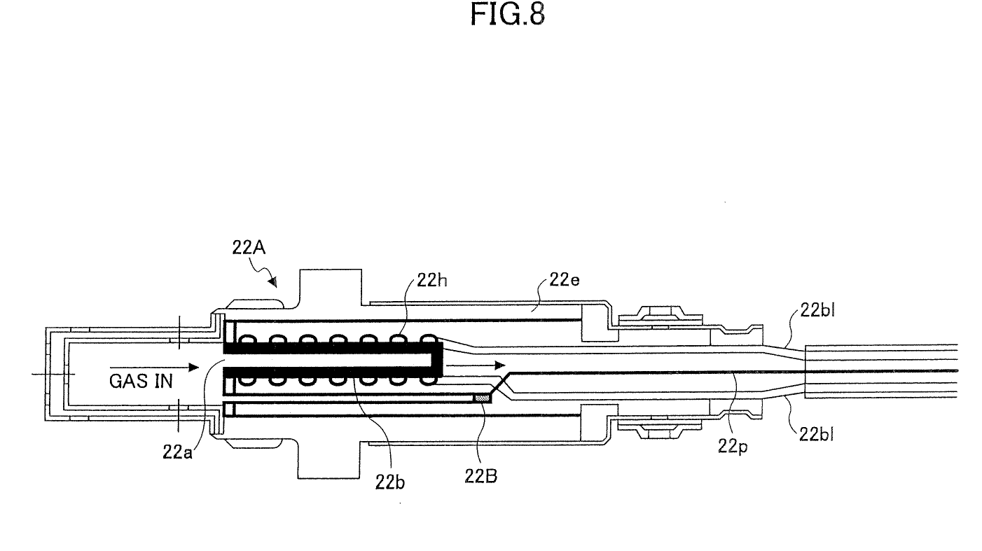

FIG. 8 shows a more detailed construction of the secondary diesel particulate filter 22A of FIG. 6.

Referring to FIG. 8, the exhaust gas in the secondary exhaust line 21A is supplied to the gas passage 22a in the secondary diesel particulate filter (cell 22b) as represented by an arrow and is discharged, after passing through the cell, in the lateral direction or rear direction. Thereby, the heater 22h on the secondary diesel particulate filter (cell 22b) is driven by the electric power supplied by a drive line 22b1 and causes incineration in the particulate matter 22c collected by the cell 22b. Further, the output signal of the diaphragm pressure gauge 22B is supplied to a control circuit via a signal line 22p.

With the secondary diesel particulate filter 22A of FIGS. 7A and 7B, the thickness W[m] of the layer 22c of the collected particulate matter is calculated from the differential pressure ΔP thus obtained according to the equation

$$Δ P = \frac{μ Q}{2 {V}_{trap}} {( α + {W}_{s} )}^{2} [ \frac{{W}_{s}}{{K}_{w} α} + \frac{1}{2 {K}_{SOOT}} ln ( \frac{α}{α - 2 W} ) + \frac{4 {FL}^{2}}{3} ( \frac{1}{{( α - 2 W )}^{4}} + \frac{1}{{α}^{4}} ) ] + \frac{ρ {{Q}^{2} ( α + Ws )}^{4}}{{V}_{trap}^{2}} [ \frac{β Ws}{4} + 2 {ζ [ \frac{L}{α} ]}^{2} ] \qquad ( 1 )$$

wherein μ represents a kinetic viscosity coefficient, Q represents the flow rate of the exhaust gas represented in terms of [m³/h], α represents an edge length of the cell, ρ represents a specific gravity of the exhaust gas, Vₜᵣₐₚ represents a filter volume, Ws represents a wall thickness, Kw represents a wall gas permeability, Kₛₒₒₜ represents a gas permeability of the collected particulate matter layer, W represents the thickness of the collected particulate matter layer, F is a coefficient (=28.454), L represents an effective filter length, β represents a coefficient of the porous wall, ç represents the differential pressure caused in the exhaust gas passing through the filter.

Next, the mass mₛₒₒₜ of the particulate matter collected by the secondary diesel particulate filter (cell 21b) is obtained according to

$$W = \frac{α - \sqrt{{α}^{2} - \frac{{m}_{soot}}{{N}_{cells} \times L \times {ρ}_{soot}}}}{2} \qquad ( 2 )$$

wherein mₛₒₒₜ represents the mass [g] of the particulate matter collected, while N_{cells} represents an aperture number of the cell at the inlet side, and ρₛₒₒₜ represents the density of the collected particulate matter.

Thus, a collection amount per unit time, PM [g/h] is obtained by dividing mₛₒₒₜ by the time [h] as measured from the previous regeneration of the secondary diesel particulate filter 22A.

Once the mass PM [g/h] of the particulate matter deposited in a unit time is obtained, the concentration of the particulate matter in the exhaust gas, PM_{conc} [g/m³], is obtained by using the flow rate Q2 [m³/h] of the exhaust gas passing through the secondary diesel particulate filter 22A as
PM[g/h]=PM_{conc}[g/m³]×Q2[m³/h]. (3)

Because the concentration PM_{conc} of the particulate matter in the exhaust gas takes the same value in the secondary exhaust line 21A and also in the exhaust lien 21, the amount of the particulate matter PM_{enter full filter} [g/h] that has flowed into the diesel particulate filter 22 is obtained from the mass PM [g/h] of the particulate matter deposited per unit time, as
PM_{enter full filter}[g/h]=PM_{conc}[g/m³]×Q1[m³/h] (4)

Further, from this, the amount of the particulate matter deposited in the filter is obtained by taking into consideration the collection efficiency of the filter. In the foregoing, Q1 represents the flow rate of the exhaust gas passing through the primary diesel particulate filter (DPF) 22. Q1 may be obtained by actual measurement or estimated from the operational state of the engine.

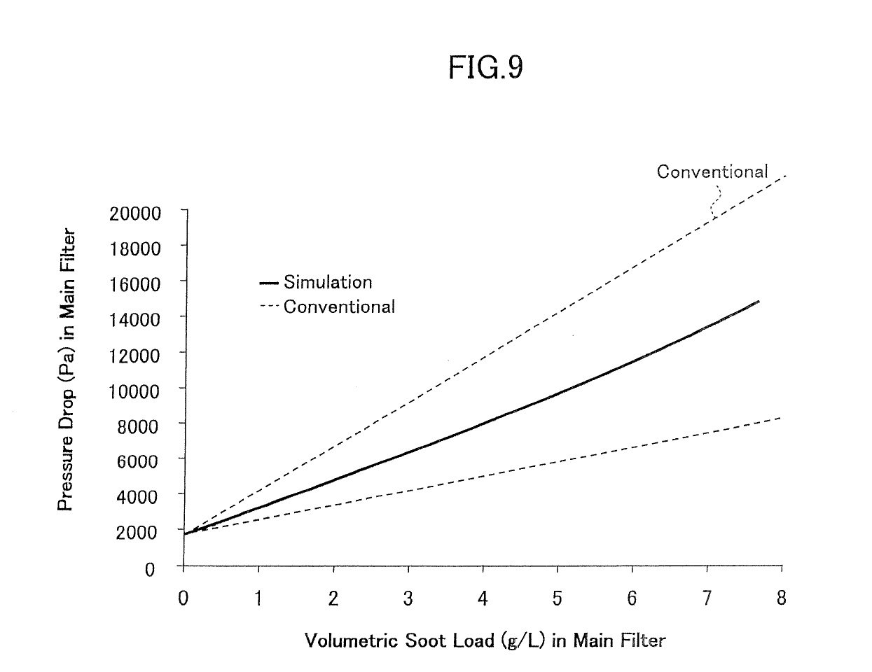

FIG. 9 shows the relationship between the differential pressure occurring across the primary diesel particulate filter (DPF) 22 of the exhaust gas purifying apparatus of the embodiment of FIG. 6 and the deposition amount of the particulate matter in the primary diesel particulate filter (DPF) 22, wherein it should be noted that the continuous line shows the case in which the deposition amount of the particulate matter in the main diesel particulate filter 22 is obtained by using the secondary diesel particulate filter 22A and Equations (1) to (4). On the other hand, the dotted line represents the case in which the deposition amount of the particulate matter in the primary diesel particulate filter (DPF) 22 is obtained directly from the differential pressure across the primary diesel particulate filter (DPF) 22.

Referring to FIG. 9, it can be seen that there can occur a variation, and hence error, of as much as about ±50% in the differential pressure across the primary diesel particulate filter (DPF) 22 when compared at the same deposition amount of the particulate matter.

Contrary to this, it is possible to obtain the amount of deposition of the particulate matter collected by the primary diesel particulate filter (DPF) 22 within the error of about ±10% by obtaining the differential pressure ΔP across the secondary diesel particulate matter and by using Equations (1) to (4).

Thus, according to the embodiment of the present invention, it becomes possible to evaluate the deposition amount of the particulate matter in the primary diesel particulate filter (DPF) 22 in the exhaust gas purifying apparatus of FIG. 6 precisely by measuring the differential pressure ΔP formed in the secondary diesel particulate filter 22A of small volume, and it becomes possible to execute the regeneration of the primary diesel particulate filter (DPF) 22 with optimum timing by way of carrying out the post injection based on the foregoing result. With this, unnecessary post injection is avoided and the fuel efficiency of the vehicle is improved.

In the construction of the embodiment of FIG. 6, it is possible to use a known Vencheri flow meter or hotwire flow meter, wherein the flow meter 24 can control the exhaust gas flow rate in the secondary exhaust line 21A generally constant within the range of about 50 to about 6000 ml/min, for example. With this, one-sided flow of the exhaust gas through the secondary exhaust line 21A is avoided, and it becomes possible to obtain the deposition amount of the particulate matter in the primary diesel particulate filter (DPF) 22 from the deposition amount obtained by using the secondary diesel particulate filter 22A, with further improved precision.

Here, it should be noted that the “differential pressure measuring part measuring a differential pressure between an inlet and an outlet of said secondary diesel particulate filter” includes not only the differential pressure gauge that measures the differential pressure between the inlet side and the outlet side of the secondary diesel particulate filter 22A but also the construction that uses a pressure gauge only at the outlet side of the diesel particulate filter 22A. With such a construction, the pressure value of the initial state (the state immediately after regeneration) is memorized and the differential pressure is calculated by measuring the pressure for the state in which there occurred deposition of the particulate material in the secondary diesel particulate filter 22A and by subtracting the pressure value thus obtained from the memorized initial pressure value.

Further, it is also possible to provide a flow meter or a flow velocity meter at the inlet side and the outlet side or only at the outlet side of the secondary diesel particulate filter for measuring the differential pressure. With such a construction, the differential pressure is obtained from the reading value of the flow meters or flow velocity meters provided at the inlet side and the outlet side of the secondary diesel particulate filter. Alternatively, the differential pressure may be obtained from the reading value of the flow meter or the flow velocity meter at the outlet side of the secondary diesel particulate filter, by comparing the reading value for the initial state (the state immediately after regeneration) and the reading value for the state where there is caused deposition of the particulate matter in the secondary diesel particulate filter.

The embodiment of the present invention has the feature of obtaining the amount of the particulate matter deposited in the primary diesel particulate filter (DPF) 22 from the differential pressure obtained for the secondary diesel particulate filter 22A by using Equations (1) to (4), and thus, any instruments including those that are used conventionally for measuring a differential pressure may be used for measuring the differential pressure of the secondary diesel particulate filter.

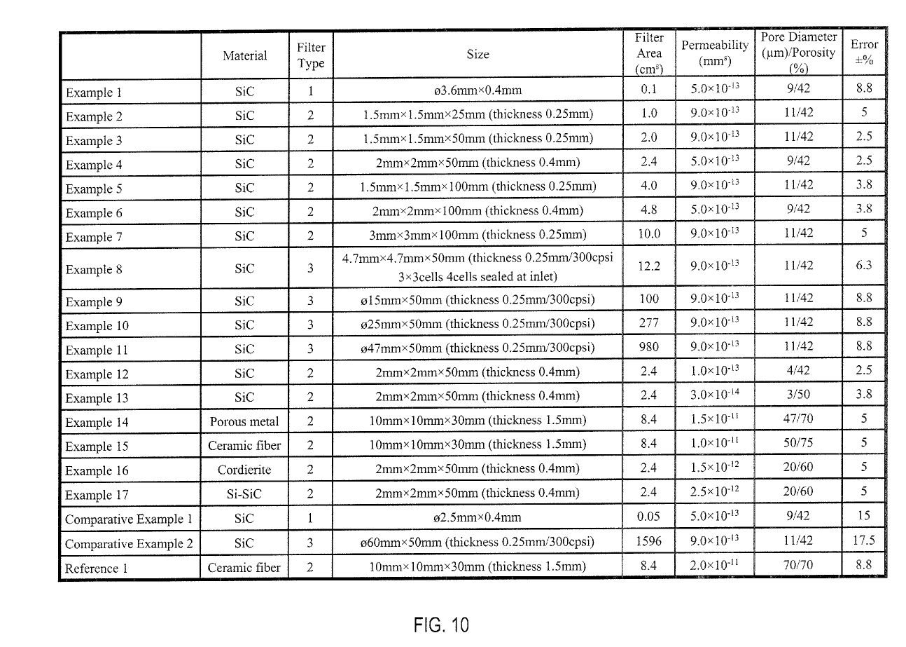

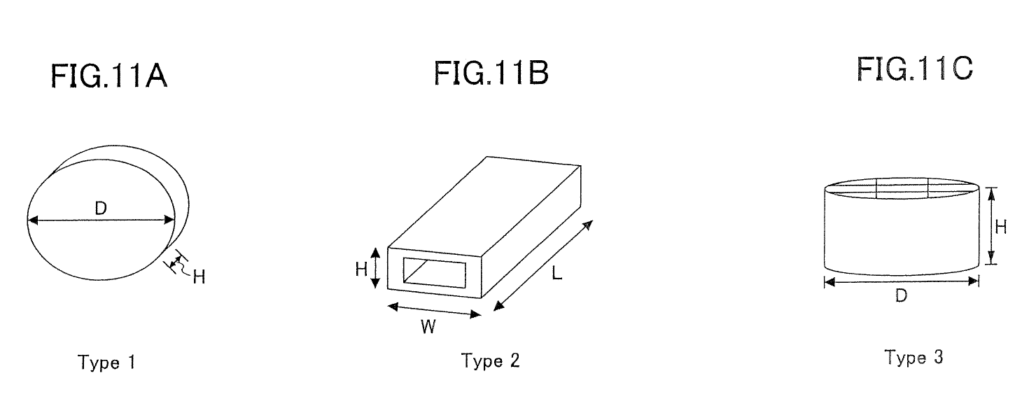

FIG. 10 shows the deposition amount of particulate matter in the primary diesel particulate filter (DPF) 22 of the embodiment of FIG. 6 evaluated from the differential pressure across the secondary diesel particulate filter 22A and the actual deposition amount of the particulate matter in the primary diesel particulate filter (DPF) 22 for the case the diesel particulate filters of the types 1 to 3 shown in FIGS. 11A to 11C are fabricated for the secondary diesel particulate filter 22A by using various materials including SiC with various filtration area values and gas permeability values. Here, it should be noted that the diesel particulate filter of the type 1 includes a disk-shaped component having a circular or elliptical front shape, while the diesel particulate filter of the type 2 has a rectangular shape similar to the one explained previously with reference to FIGS. 7A and 7B and includes an opening of a corresponding rectangular shape formed therein such that the opening does not penetrate therethrough. Further, the diesel particulate filter of the type 3 of FIG. 11C is formed of a diesel particulate filter of honeycomb structure shown in FIG. 2B.

Referring to FIG. 10, there is formed a diesel particulate filter of type 1 of SiC in Example 1 with a diameter D of 3.6 mm and a height H of 0.4 mm, wherein the diesel particulate filter of Example 1 is characterized by an average pore diameter of 9 μm, a porosity of 42%, a filtration area of 0.1 cm² and a wall gas permeability (permeability) of 5.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±8.8%.

In Example 2, there is formed a diesel particulate filter of type 2 of SiC with a width W and height H of 1.5 mm, a length L of 25 mm and a wall thickness of 0.25 mm, wherein the diesel particulate filter of Example 2 is characterized by an average pore diameter of 11 μm, a porosity of 42%, a filtration area of 1.0 cm² and a wall gas permeability (permeability) of 9.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±5%.

In Example 3, there is formed a diesel particulate filter of type 2 of SiC with a width W and height H of 1.5 mm, a length L of 50 mm and a wall thickness of 0.25 mm, wherein the diesel particulate filter of Example 3 is characterized by an average pore diameter of 11 μm, a porosity of 42%, a filtration area of 2.0 cm² and a wall gas permeability (permeability) of 9.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±2.5%.

In Example 4, there is formed a diesel particulate filter of type 2 of SiC with a width W and height H of 2 mm, a length L of 50 mm and a wall thickness of 0.4 mm, wherein the diesel particulate filter of Example 4 is characterized by an average pore diameter of 9 μm, a porosity of 42%, a filtration area of 2.4 cm² and a wall gas permeability (permeability) of 5.0×10⁻¹³m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±2.5%.

In Example 5, there is formed a diesel particulate filter of type 2 of SiC with a width W and height H of 1.5 mm, a length L of 110 mm and a wall thickness of 0.25 mm, wherein the diesel particulate filter of Example 5 is characterized by an average pore diameter of 11 μm, a porosity of 42%, a filtration area of 4.0 cm² and a wall gas permeability (permeability) of 9.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±3.8%.

In Example 6, there is formed a diesel particulate filter of type 2 of SiC with a width W and height H of 2 mm, a length L of 100 mm and a wall thickness of 0.4 mm, wherein the diesel particulate filter of Example 6 is characterized by an average pore diameter of 9 μm, a porosity of 42%, a filtration area of 4.8 cm² and a wall gas permeability (permeability) of 5.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±3.8%.

In Example 7, there is formed a diesel particulate filter of type 2 of SiC with a width W and height H of 3 mm, a length L of 100 mm and a wall thickness of 0.25 mm, wherein the diesel particulate filter of Example 7 is characterized by an average pore diameter of 11 μm, a porosity of 42%, a filtration area of 10.0 cm² and a wall gas permeability (permeability) of 9.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±5.0%.

In Example 8, there is formed a diesel particulate filter of type 3 of SiC in the form of a rectangular body with a width W and height H of 4.7 mm, a length L of 50 mm and a wall thickness of 0.25 mm, wherein the diesel particulate filter of Example 8 is formed with cells with a density of 300 cells per square inch (300 cpsi). There are provided 9 cells (=3×3) in total. These cells are sealed at alternate ends, wherein four cells are sealed at the inlet end. The diesel particulate filter of Example 8 has an average pore diameter of 11 μm, a porosity of 42% and is characterized by the filtration area of 12.2 cm² and a wall gas permeability (permeability) of 9.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±6.3%.

In Example 9, there is formed a diesel particulate filter of type 3 of SiC with a diameter of 15 mm, a height H of 50 mm, wherein the diesel particulate filter of Example 9 is formed with cells with a density of 300 cells per square inch (300 cpsi) and a wall thickness of 0.25 mm. The diesel particulate filter of Example 9 has an average pore diameter of 11 μm, a porosity of 42% and is characterized by the filtration area of 100.0 cm² and a wall gas permeability (permeability) of 9.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±8.8%.

In Example 10, there is formed a diesel particulate filter of type 3 of SiC with a diameter of 25 mm, a height H of 50 mm, wherein the diesel particulate filter of Example 10 is formed with cells with a density of 300 cells per square inch (300 cpsi) and a wall thickness of 0.25 mm. The diesel particulate filter of Example 10 has an average pore diameter of 11 μm, a porosity of 42% and is characterized by the filtration area of 277.0 cm² and a wall gas permeability (permeability) of 9.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±8.8%.

In Example 11, there is formed a diesel particulate filter of type 3 of SiC with a diameter of 47 mm, a height H of 50 mm, wherein the diesel particulate filter of Example 11 is formed with cells with a density of 300 cells per square inch (300 cpsi) and a wall thickness of 0.25 mm. The diesel particulate filter of Example 11 has an average pore diameter of 11 μm, a porosity of 42% and is characterized by the filtration area of 980.0 cm² and a wall gas permeability (permeability) of 9.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±8.8%.

In Example 12, there is formed a diesel particulate filter of type 2 of SiC with a width W and height H of 2 mm, a length L of 50 mm and a wall thickness of 0.4 mm, wherein the diesel particulate filter of Example 12 is characterized by an average pore diameter of 4 μm, a porosity of 42%, a filtration area of 2.4 cm² and a wall gas permeability (permeability) of 1×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±2.5%.

In Example 13, there is formed a diesel particulate filter of type 2 of SiC with a width W and height H of 2 mm, a length L of 50 mm and a wall thickness of 0.4 mm, wherein the diesel particulate filter of Example 13 is characterized by an average pore diameter of 3 μm, a porosity of 50%, a filtration area of 2.4 cm² and a wall gas permeability (permeability) of 3.0×10⁻¹⁴ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±3.8%.

In Example 14, there is formed a diesel particulate filter of type 2 of a porous metal with a width W and height H of 10 mm, a length L of 30 mm and a wall thickness of 1.5 mm, wherein the diesel particulate filter of Example 14 is characterized by an average pore diameter of 47 μm, a porosity of 70%, a filtration area of 8.4 cm² and a wall gas permeability (permeability) of 1.5×10⁻¹¹ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±5.0%.

In Example 15, there is formed a diesel particulate filter of type 2 of ceramic fiber with a width W and height H of 10 mm, a length L of 30 mm and a wall thickness of 1.5 mm, wherein the diesel particulate filter of Example 15 is characterized by an average pore diameter of 50 μm, a porosity of 75%, a filtration area of 8.4 cm² and a wall gas permeability (permeability) of 1.0×10⁻¹¹ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±5.0%.

In Example 16, there is formed a diesel particulate filter of type 2 of cordierite with a width W and height H of 2 mm, a length L of 50 mm and a wall thickness of 0.4 mm, wherein the diesel particulate filter of Example 16 is characterized by an average pore diameter of 20 μm, a porosity of 60%, a filtration area of 2.4 cm² and a wall gas permeability (permeability) of 1.5×10⁻¹² m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±5.0%.

In Example 17, there is formed a diesel particulate filter of type 2 of Si—SiC with a width W and height H of 2 mm, a length L of 50 mm and a wall thickness of 0.4 mm, wherein the diesel particulate filter of Example 17 is characterized by an average pore diameter of 20 μm, a porosity of 60%, a filtration area of 2.4 cm² and a wall gas permeability (permeability) of 2.5×10⁻¹² m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±5.0%.

In Comparative Example 1, there is formed a diesel particulate filter of type 1 of SiC with a diameter D of 2.5 mm and a height of 0.4 mm, wherein the diesel particulate filter of Comparative Example 1 is characterized by an average pore diameter of 9 μm, a porosity of 42%, a filtration area of 0.05 cm² and a wall gas permeability (permeability) of 5.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±15.0%.

In Comparative Example 2, there is formed a diesel particulate filter of type 3 of SiC with a diameter D of 60 and a height H of 50 mm. With the diesel particulate filter of Comparative Example 2, cells are formed with a density of 300 cells per square inch (300 cpsi) with a wall thickness of 0.25 mm, wherein the diesel particulate filter of Comparative Example 2 is characterized by an average pore diameter of 11 μm, a porosity of 42%, a filtration area of 1596.0 cm² and a wall gas permeability (permeability) of 9.0×10⁻¹³ m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±17.5%.

Further, with a Reference Example 1, there is formed a diesel particulate filter of type 2 of ceramic fiber with a width W and height H of 10 mm, a length L of 30 mm and a wall thickness of 1.5 mm, wherein the diesel particulate filter of Reference Example 1 is characterized by an average pore diameter of 70 μm, a porosity of 70%, a filtration area of 8.4 cm² and a wall gas permeability (permeability) of 2.0×10⁻¹¹m². In the case this diesel particulate filter is used for the secondary diesel particulate filter 22A in the exhaust gas purifying apparatus of FIG. 6, it was observed that the error between the actual deposition amount of the particulate matter in the primary diesel particulate filter (DPF) 22 and the evaluation value thereof evaluated from the differential pressure across the secondary diesel particulate filter 22A was ±8.8%.

From FIG. 10, it is concluded that it is preferable that the diesel particulate filter used for the secondary diesel particulate filter 22A has the filtration area in the range of about 0.1 to about 1000 cm², more preferably about 1 to about 10 cm² and the wall gas permeability (permeability) in the range of about 1.0×10⁻¹⁵ to about 1.0×10⁻¹¹ m², more preferably about 1.0×10⁻¹³ to about 1.0×10⁻¹² m².

It should be noted that the foregoing experiment has been made by providing the exhaust gas purifying apparatus of FIG. 6 to the exhaust line of a 2-litter diesel engine and running the engine for 5 hours at the condition of 3000 rpm/50 N. Thereby, the actual deposition amount of the particulate matter in the primary diesel particulate filter (DPF) 22 was obtained by way of weight measurement, and the value thus obtained is compared with the evaluated value obtained from the differential pressure across the secondary diesel particulate filter 22A.

In the experiment, a filter having a diameter of 143.8 mm and a height of 150 mm was used for the primary diesel particulate filter (DPF) 22.

More specifically, the primary diesel particulate filter (DPF) 22 was formed by: forming a unit in the width and height of 34.4 mm and the length of 150 mm by using the cells of the average pore diameter of 11 μm and the porosity of 42%, wall thickness of 0.25 mm and the cell density of 300 cpsi; binding 16 (=4×4) units with each other, and machining the side surfaces. Further, in the foregoing experiment, a diameter of 150 mm was used for the exhaust line 21 and the diameter of the secondary exhaust line 21A was set to 10 mm. Thereby, regeneration of the secondary diesel particulate filter 22A was conducted each time the particulate matter is deposited in the secondary diesel particulate filter 22A with the amount of 0.5 g/l.

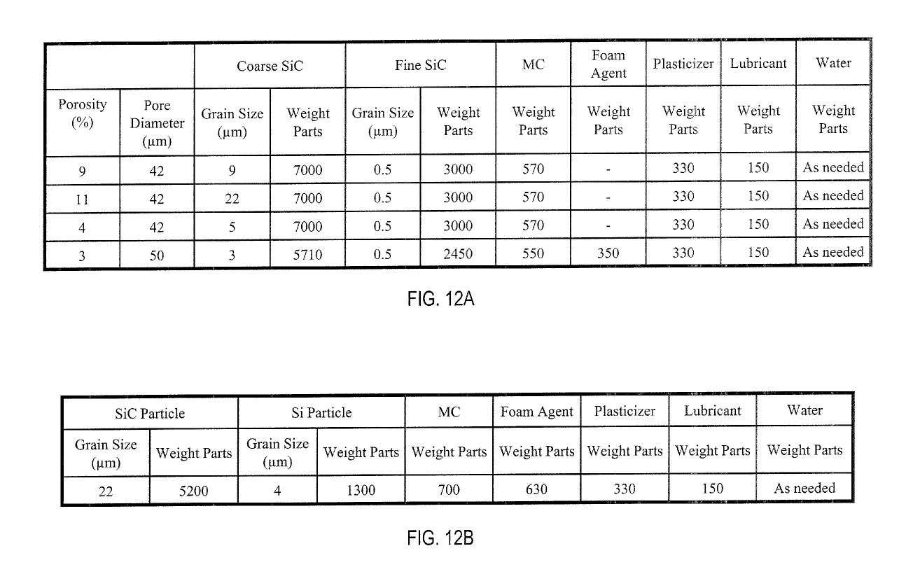

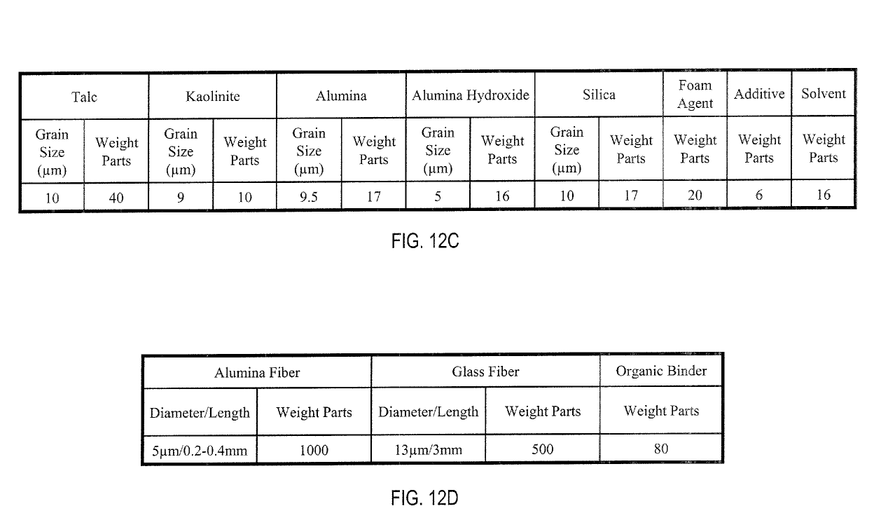

FIG. 12A shows the mixing of source materials when forming the diesel particulate filter of SiC with the average pore diameters and porosities of: 9 μm and 42%; 11 μm and 42%; 4 μm and 42%; and 3 μm and 50% used in the foregoing Experiments 1 to 13 and Comparative Experiments 2 and 3.

Referring to FIG. 12A, it can be seen that the SiC diesel particulate filter having the average pore diameter of 9 μm and porosity of 42% can be formed by kneading SiC coarse particles having the grain diameter of 9 μm and SiC fine particles having the grain diameter of 0.5 μm respectively with 7000 weight parts and 3000 weight parts together with an organic binder (MC) of 570 weight parts, a plasticizer of 330 weight parts, a lubricant of 150 weight parts and water of appropriate amount, wherein the source mixture thus obtained is shaped to a predetermined shape such as honeycomb shape by an extruding process. After the extruding process, the green body thus obtained is subjected to a degreasing process conducted for 3 hours at 300° C., followed by a firing process conducted at 2200° C. for 3 hours.

Referring to FIG. 12A, it can be seen that the SiC diesel particulate filter having the average pore diameter of 11 μm and porosity of 42% can be formed by kneading SiC coarse particles having the grain diameter of 22 μm and SiC fine particles having the grain diameter of 0.5 μm respectively with 7000 weight parts and 3000 weight parts together with an organic binder (MC) of 570 weight parts, a plasticizer of 330 weight parts, a lubricant of 150 weight parts and water of appropriate amount, wherein the source mixture thus obtained is shaped to a predetermined shape such as honeycomb shape by an extruding process. After the extruding process, the green body thus obtained is subjected to a degreasing process conducted for 3 hours at 300° C., followed by a firing process conducted at 2200° C. for 3 hours.

Further, referring to FIG. 12A, it can be seen that the SiC diesel particulate filter having the average pore diameter of 4 μm and porosity of 42% can be formed by kneading SiC coarse particles having the grain diameter of 5 μm and SiC fine particles having the grain diameter of 0.5 μm respectively with 7000 weight parts and 3000 weight parts together with an organic binder (MC) of 570 weight parts, a plasticizer of 330 weight parts, a lubricant of 150 weight parts and water of appropriate amount, wherein the source mixture thus obtained is shaped to a predetermined shape such as honeycomb shape by an extruding process. After the extruding process, the green body thus obtained is subjected to a degreasing process conducted for 3 hours at 300° C., followed by a firing process conducted at 2200° C. for 3 hours.

Further, referring to FIG. 12A, it can be seen that the SiC diesel particulate filter having the average pore diameter of 3 μm and porosity of 50% can be formed by kneading SiC coarse particles having the grain diameter of 3 μm and SiC fine particles having the grain diameter of 0.5 μm respectively with 5710 weight parts and 2450 weight parts together with an organic binder (MC) of 550 weight parts, a plasticizer of 350 weight parts, a lubricant of 350 weight parts and water of appropriate amount, wherein the source mixture thus obtained is shaped to a predetermined shape such as honeycomb shape by an extruding process. After the extruding process, the green body thus obtained is subjected to a degreasing process conducted for 3 hours at 300° C., followed by a firing process conducted at 2200° C. for 3 hours.

FIG. 12B shows the mixing of source materials when forming the diesel particulate filter of Si—SiC used in Example 17 and having the average pore diameter of 20 μm and porosity of 60%.

Referring to FIG. 12B, it can be seen that the Si—SiC diesel particulate filter having the average pore diameter of 20 μm and porosity of 60% can be formed by kneading SiC coarse particles having the grain diameter of 22 μm and SiC fine particles having the grain diameter of 4 μm respectively with 5210 weight parts and 1300 weight parts together with an organic binder (MC) of 700 weight parts, a plasticizer of 330 weight parts, a lubricant of 150 weight parts and water of appropriate amount, wherein the source mixture thus obtained is shaped to a predetermined shape by an extruding process. After the extruding process, the green body thus obtained is subjected to a degreasing process conducted for 3 hours at 300° C., followed by a firing process conducted at 1650° C. for 3 hours.

FIG. 12C shows the mixing of source materials of cordierite ceramic used in Example 16 and having the average pore diameter of 20 μm and porosity of 60%.

Referring to FIG. 12C, it can be seen that the cordierite diesel particulate filter having the average pore diameter of 20 μm and porosity of 60% can be formed by kneading talc particles having the grain diameter of 10 μm, kaolin particles having the grain diameter of 9 μm, alumina particles having the grain diameter of 9.5 μm, aluminum hydroxide particles having the grain diameter of 5 μm, and silica particles having the grain diameter of 10 μm with respective weight parts of 40, 10, 17, 16 and 18, together with a foaming agent of 20 weight parts, a plasticizer of 6 weight parts, a solvent of 16 weight parts, wherein the source mixture thus obtained is shaped to a predetermined shape by an extruding process. After the extruding process, the green body thus obtained is subjected to a degreasing process conducted for 3 hours at 300° C., followed by a firing process conducted at 1400° C. for 3 hours.

FIG. 12D shows the outline of manufacturing the diesel particulate filter of ceramic fiber used with Example 15 and Reference Example 1.

Referring to FIG. 12D, alumina fibers having an average diameter of 5 μm and a length of 0.2 to 0.4 mm and glass fibers having an average diameter of 13 μm and a length of 3 mm are dispersed in water respectively with 1000 weight parts and 500 weight parts together with an organic binder of 80 weight parts, and sheet is formed therefrom by a papeheating process. Further, the sheet thus obtained is heated at the temperature of 950° C. for 5 hours. Further, after treatment in acid, heating is conducted again at the temperature of 1050° C. for 5 hours. Thereby, the diesel particulate filter is obtained by shaping the sheet thus obtained according to a predetermined shape.

In Example 14 of FIG. 11, it is possible to use a three-dimensional mesh structure of a Ni—C—W alloy (trade name MA23) marketed by Mitsubishi Material for the diesel particulate filter after a compression processing such that the predetermined average pore diameter and porosity are attained.

### Second Embodiment

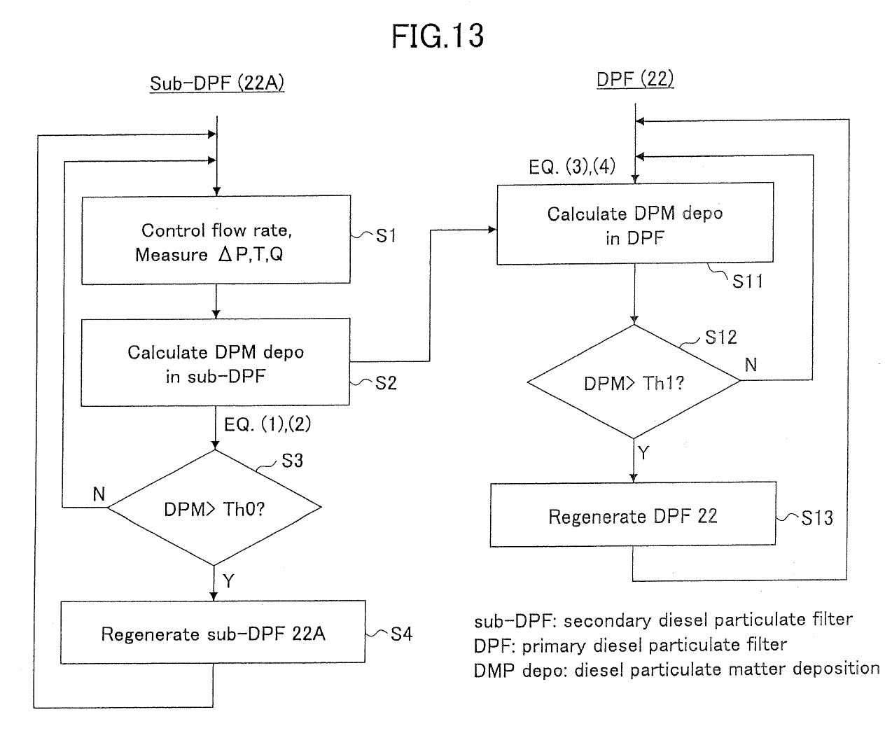

FIG. 13 is a flowchart showing the exhaust gas purifying method according to a second embodiment of the present invention that uses the exhaust gas purifying apparatus of the embodiment of FIG. 6.

Referring to FIG. 13, the exhaust gas flow rate Q is detected by the flow meter 24 in the step 1 and the differential pressure ΔP across the secondary diesel particulate filter 22A is detected by the differential pressure gauge 22B. Further, the temperature of the exhaust gas is detected by using the temperature of the temperature measuring part T1.

Next, in the step 2, the layer thickness W of the particulate matter collected by the secondary diesel particulate filter 22A is obtained from the differential pressure ΔP detected in the step 1 according to Equation (1). Here, it should be noted that the temperature T of the exhaust gas may be obtained by using the temperature measuring part T2 of the primary diesel particulate filter (DPF) 22 in place of using the temperature measuring part T1 of the secondary diesel particulate filter 22A as in the present case. Further, the temperature T may be calculated from the temperatures of the temperature measuring parts T1 and T2 (in the form of average value, maximum value, minimum value, for example). From the viewpoint of calculating the amount of the particulate matter more precisely, it is preferable to use the temperature of the temperature measuring part T1 of the secondary diesel particulate filter 22A. For the thermometer, a thermocouple may be used, while it is also possible to use anything as long as it can measure the temperature. While it is preferable to measure the temperature of the exhaust gas inside the exhaust pipe, it is also possible to measure the temperature of the filter or the cell.

Further, in the step 2, the mass mₛₒₒₜ of the particulate matter collected by the cell 21b is obtained from the layer thickness W detected in the step 1 by using Equation (2) mentioned previously.

Further, in the step 3, it is judged whether or not the mass mₛₒₒₜ of the layered particulate matter deposited in the cell 22b of the secondary diesel particulate filter 22A has exceeded a predetermined threshold Th0, and if the result is NO, the process returns to the step 1.

When the mass mₛₒₒₜ of the layered particulate matter deposited in the cell 22b of the secondary diesel particulate filter 22A has exceeded the predetermined threshold Th0 in the step 3, the heater 22h is activated in the step 4 and the particulate matter 22c is removed by burning.

Meanwhile, in the process of FIG. 8, the concentration PM of the particulate matter in the exhaust gas is obtained in the step 11 from Equation (3) while using the mass mₛₒₒₜ of the collected particulate matter in the cell 22b obtained in the step 2, and the deposited amount PM_{enter full filter} of the particulate deposited in the principal diesel particulate filter 22 is obtained from Equation (4) and from the collection efficiency of the primary diesel particulate filter (DPF) 22.

Thus, in the step 12, it is judged whether or not the deposited amount PM_{enter full filter} of the particulate matter in the primary diesel particulate filter (DPF) 22 exceeds a predetermined threshold value Th1, and if the result of judgment is NO, the operation returns to the step S11.

In the event it is judged in the step 12 that the deposited amount PM_{enter full filter} of the particulate matter in the primary diesel particulate filter (DPF) 22 exceeds the predetermined threshold value Th1, post injection is executed in the step 13 by controlling an engine control unit (ECU), and the deposited particulate matter in the primary diesel particulate filter (DPF) 22 is removed by burning. Thereby, regeneration of filter is achieved.

With the process of FIG. 13, it is possible to carry out the regeneration of the secondary diesel particulate filter 22A and the primary diesel particulate filter (DPF) 22 independently, and thus, it is possible to always maintain the deposited amount of the particulate matter 22c, or the amount of the soot layer, in the cell 22b, which constitutes the secondary diesel particulate filter 22A, to be a small value of about 0.5 g/l or less. With such a construction, it becomes possible to improve the sensitivity of the particulate matter sensor that uses the secondary diesel particulate filter 22A.

With the construction of the embodiment of FIG. 6, in which the valve 23 is inserted into the secondary exhaust line 21A, there is caused no such a situation that the exhaust gas flows predominantly through the secondary diesel particulate filter where regeneration has been made even when the regeneration of the secondary diesel particulate filter 22A is conducted independently to the primary diesel particulate filter (DPF) 22, and there is caused no error in the evaluation of the deposited amount of the particulate matter in the primary diesel particulate filter (DPF) 22.

Thereby, it should be noted that there is no need for the valve 23 to maintain the exhaust gas flow rate in the secondary exhaust line 21A exactly at a constant level but it is just sufficient to avoid extreme deviation of the exhaust gas flow to the secondary exhaust line 21A.

Thus, in the second embodiment noted above, the differential pressure ΔP, the exhaust gas temperature T and the exhaust gas flow rate Q are measured (step 1), the mass of the particulate matter collected by the secondary diesel particulate filter is obtained by using Equations (1) and (2) from the foregoing result of measurement (step 2), and the amount of the particulate matter collected by the primary diesel particulate filter is obtained from the amount of the particulate matter collected in the secondary diesel particulate filter by using Equations (3) and (4) and further using the collection efficiency of the primary diesel particulate filter (step 11).

In FIG. 8, and also in FIG. 9 to be explained below, the primary diesel particulate filter (DPF) 22 is designated as DPF while the secondary diesel particulate filter 22A is designated as sub-DPF. Further, the deposition of diesel particulate matter is designated as DPM depo.

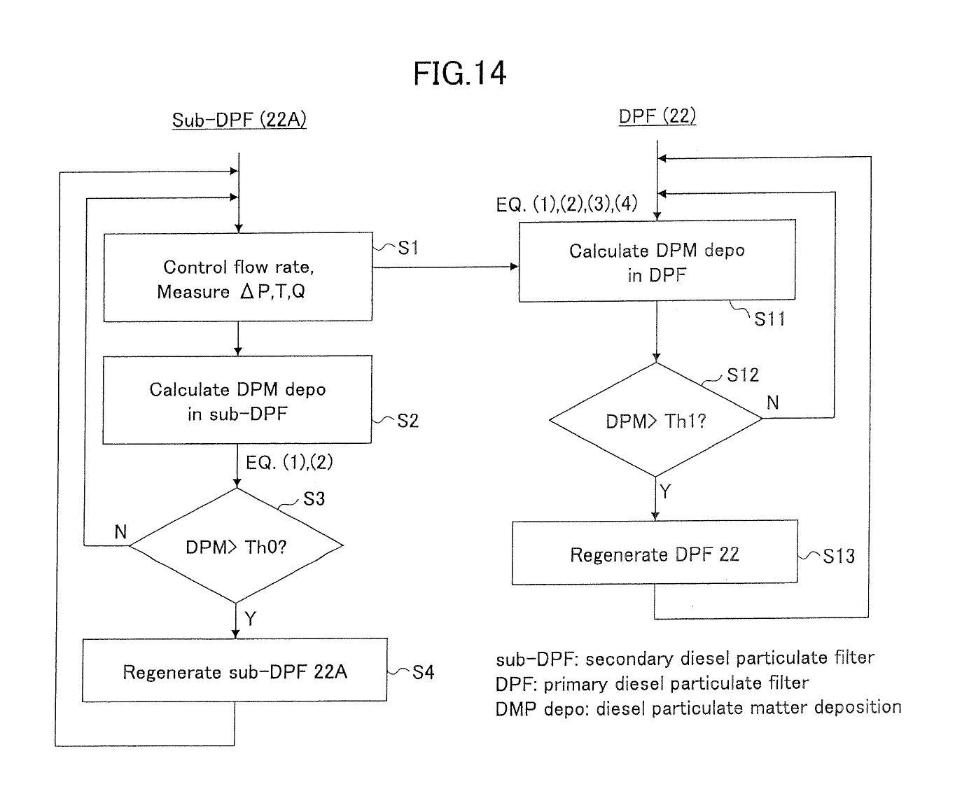

On the other hand, the process of obtaining the amount of the particulate matter collected in the primary diesel particulate filter may be modified as shown in FIG. 14.

Thus, in FIG. 14, the process for obtaining the amount of the particulate matter collected by the primary diesel particulate filter (step 11) is carried out in parallel with the process of obtaining the amount of the particulate matter collected by the secondary diesel particulate filter (step 2), while using the result of measurement obtained in the step 1.

### Third Embodiment

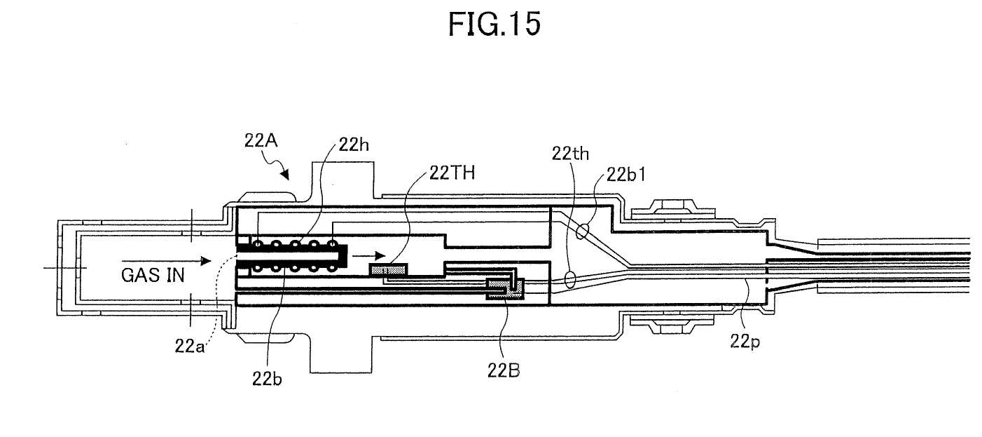

FIG. 15 shows the construction of a particulate matter sensor according to a third embodiment of the present invention, wherein those parts corresponding to the parts described previously are designated by the same reference numerals and the description thereof will be omitted.

With the embodiment of FIG. 15, there is further provided a thermistor 22Th outside the housing of the particulate matter detection sensor as a temperature measuring part, wherein a resistance value of the thermistor 22Th is read by a control circuit via a signal line 22th.

With the embodiment of FIG. 15, the thermistor 22Th is integrated into the housing of the particulate sensor, and as a result, it becomes possible to construct the particulate matter sensor in a compact size, suitable for providing at any desired location the exhaust line of the diesel engine.

### Fourth Embodiment

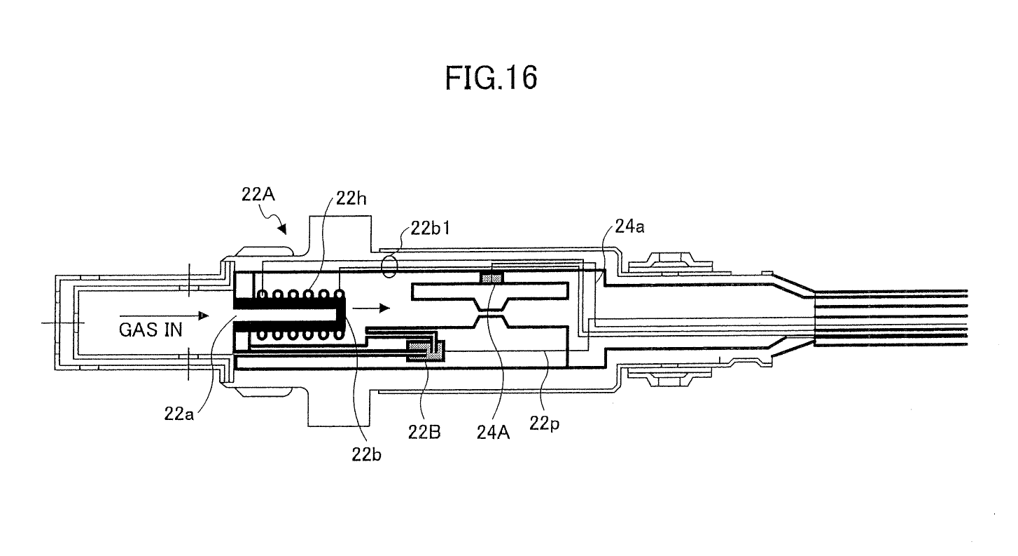

FIG. 16 shows the construction of a particulate matter sensor according to a fourth embodiment of the present invention, wherein those parts corresponding to the parts described previously are designated by the same reference numerals and the description thereof will be omitted.

With the embodiment of FIG. 16, there is provided a flow meter 24A of a differential-pressure venturi tube inside the housing of the particulate matter sensor as the flow meter 24, wherein the output of the flow meter 24A is forwarded to the control circuit via a signal line 24a.

Thus, with the embodiment of FIG. 16, it becomes possible to read the flow rate of the exhaust gas flowing through the cell 22b by the flow meter 24A of the differential-pressure venturi tube. Because the flow meter 24A is integrated into the housing of the particulate matter sensor, the particulate matter sensor is constructed to have a compact size, and it becomes possible to provide the particulate matter sensor at any desired location of the exhaust line of the diesel engine.

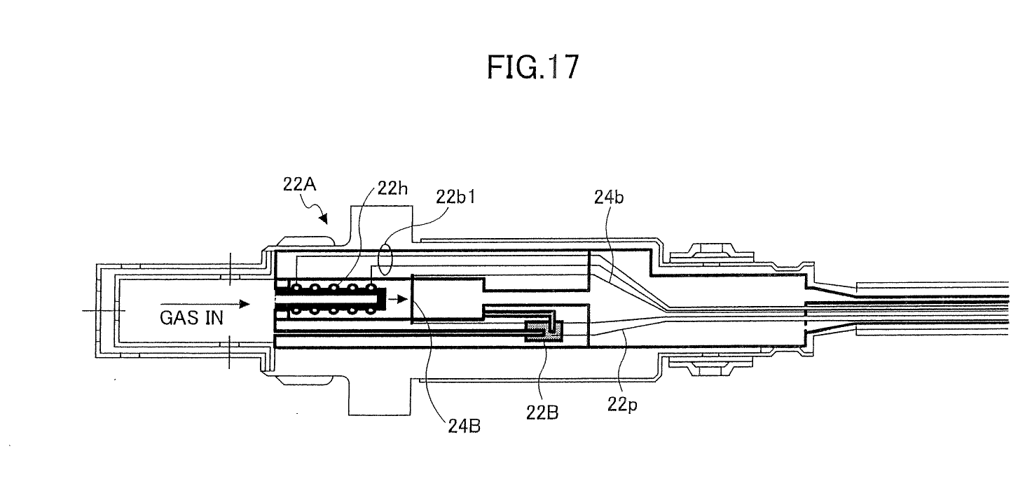

FIG. 17 shows a modification of the particulate sensor of the embodiment of FIG. 16.

Referring to the embodiment of FIG. 17, there is provided a simple hot-wire flow meter 24B with the present embodiment in place of the flow meter 24A of differential-pressure venturi tube of FIG. 13, and the flow rate of the exhaust gas flowing through the cell 22b is read by the control circuit via a signal line 24b.

Further, while the explanation heretofore has been made for the case of using a honeycomb component of SiC for the primary diesel particulate filter (DPF) 22 and the secondary diesel particulate filter 22A, the embodiment of the present invention is by no means limited to such particular filter components, and it is also possible to use a composite material containing silicon carbide by about 60% or more, such as a composite of silicon carbide and metal such as silicon (in the present invention such a composite should also be referred to as silicon carbide), a nitride such as aluminum nitride, silicon nitride, boron nitride, tungsten nitride, or the like, a carbide such as Zirconium carbide, titanium carbide, tantalum carbide, tungsten carbide, or the like, an oxide such as alumina, zirconium oxide, cordierite, mullite, silica, aluminum titanate, or a porous body of metal such as stainless steel. Further, it is possible to use a structural body such as corrugate or element plate in addition to the honeycomb structure.

The exhaust gas purifying apparatus by using the particulate matter sensor of the embodiment of the present invention has a compact size and is applicable not only to large vehicles such as trucks or industrial machines but also to passenger cars.

Obviously, numerous modifications and variations of the present invention are possible in light of the above teachings. It is therefore to be understood that within the scope of the appended claims, the invention may be practiced otherwise than as specifically described herein.

1. A particulate matter detection sensor, comprising:
a particulate matter detection filter; and
a differential pressure measuring part measuring a differential pressure between an inlet and an outlet of said particulate matter detection filter,
wherein said particulate matter detection filter has a filtration area in the range of about 0.1 to about 1000 cm².

2. The particulate matter detection sensor as claimed in claim 1, wherein said filtration area is in the range of about 1 to about 10 cm².

3. The particulate matter detection sensor as claimed in claim 1, wherein said particulate matter detection filter has a wall gas permeability in the range of about 1.0×10⁻¹⁵ to about 1.0×10⁻¹¹ m².

4. The particulate matter detection sensor as claimed in claim 3, wherein said wall gas permeability is in the range of about 1.0×10⁻¹³ to about 1.0×10⁻¹² m².

5. The particulate matter detection sensor as claimed in claim 1, further comprising a temperature measuring part measuring a temperature.

6. The particulate matter detection sensor as claimed in any of claims 1-5, further comprising a flow meter or an equivalent meter that measures a flow rate of an exhaust gas flowing through said particulate detection filter.

7. The particulate matter detection sensor as claimed in claim 1, further comprising a vessel, at least one of said particulate detection filter, said differential pressure measuring part, said temperature measuring part and said flow meter is accommodated in said vessel.

8. The particulate matter detection sensor as claimed in claim 1, wherein said particulate detection filter comprises any of SiC, aluminum nitride, silicon carbide, boron nitride, tungsten nitride, zirconium carbide, titanium carbide, tantalum carbide, tungsten carbide, alumina, zirconium oxide, cordierite, mullite, silica, and aluminum titanate.
